(19) United States
(12) Patent Application Publication
(10) Pub. No.: US 2025/0112467 A1
(43) Pub. Date: Apr. 3, 2025

(54) Protection And Control Scheme For Utility Tie And Industrial Cogeneration System

(71) Applicant: Google LLC, Mountain View, CA (US)

(72) Inventors: Kei Hao, Anaheim, CA (US); Hammad Ahmad Khan, Leesburg, VA (US); Krishnanjan Gubba Ravikumar, Ashburn, VA (US)

(21) Appl. No.: 18/900,030

(22) Filed: Sep. 27, 2024

Related U.S. Application Data
(60) Provisional application No. 63/541,422, filed on Sep. 29, 2023.

(51) Int. Cl. H02J 3/38; H02H 3/08; H02J 9/06

(52) U.S. Cl. CPC H02J 3/38; H02J 9/06; H02H 3/08

(57) ABSTRACT

The disclosed technology is directed to a power distribution architecture or network, and a protection and control scheme for the power distribution network. In one aspect of the disclosed technology, the backup generator bus is used as a tie between two independent power sources or mains used to supply electrical power to loads on the power distribution network. Another aspect of the disclosed technology is a protection scheme to detect and locate faults that may occur on the power distribution network. Another aspect of the disclosed technology is a control method or process for transferring loads from one source or main to another source or main in the event of planned or emergency transfers.

### CROSS-REFERENCE TO RELATED APPLICATIONS

The present application claims the benefit of the filing date of U.S. Provisional Patent Application No. 63/541,422, filed Sep. 29, 2023, the disclosure of which is hereby incorporated herein by reference.

### BACKGROUND

Datacenters house the servers, storage elements and other equipment or facilities on which modern-day networked computing relies. The electricity that powers a datacenter is typically provided via a system in which a power utility serves as the main power source and on-site backup generators supply power in the event the power utility supply becomes unavailable. Given that the information processed within a datacenter is often mission-critical to users or customers, any disruption in the power supply to a datacenter can result in loss of data, data corruption or other events that may unsatisfactorily impact business operations. Accordingly, while the power system for a datacenter needs to be architected in a cost-effective manner, it needs to be also architected so as to meet reliability and availability requirements.

### SUMMARY

The disclosed technology is directed to a power distribution architecture or network, and power protection and control schemes for the power distribution network. One aspect of the disclosed technology is a power distribution network architecture in which a backup generator bus is used as a tie between two independent power sources or mains used to supply electrical power to loads on the power distribution network. Another aspect of the disclosed technology is a protection scheme to detect and locate faults that may occur on the power distribution network. Another aspect of the disclosed technology is a control method or process for transferring loads from one source or main to another source or main, or transferring the loads so that they are fed by the generators, in the event of planned or emergency transfers. The disclosed technology is described in the context of a datacenter but may be employed in any facility, e.g., manufacturing plants, laboratories, etc., where power interruptions are mitigated via backup generators.

For example, one aspect of the disclosed technology is a power distribution system. The power distribution system comprises a first source coupled to a first bus through a first source breaker; a second source coupled to a second bus through a second source breaker; one or more generators coupled to a generator bus through a plurality of generator breakers such that each generator is coupled to the generator bus by a different generator breaker; a first set of loads coupled to the first bus; and a second set of loads coupled to the second bus, and wherein the generator bus operates as a tie used in providing power from the second source to the first set of loads when the first source is unavailable or as a tie used in providing power from the first source to the second set of loads when the second source is unavailable.

In accordance with this aspect of the disclosed technology, the system may comprise a first generator bus breaker (“FA”) and third source breaker (“GA”) coupled between the generator bus and the first bus. Further, the system may comprise a second generator bus breaker (“FB”) and fourth source breaker (“GB”) coupled between the generator bus and the second bus. Further still, when the generator bus is used as the tie in providing power from the second source to the first set of loads when the first source is unavailable, the first source breaker is open and the third source breaker, the first generator source breaker, the second generator source breaker, the fourth source breaker, and the second source breaker are closed. In addition, when the generator bus is used as the tie in providing power from the first source to the second set of loads when the second source is unavailable, the second source breaker is open and the third source breaker, the first generator source breaker, the second generator source breaker, the fourth source breaker, and the first source breaker are closed. Further still, the generator bus operates to provide power from the one or more generators when the first source and second source are unavailable. In addition, when the generator bus operates as a backup bus used in providing power from the one or more generators when the first and second source breakers are opened and the third source breaker, the first generator source breaker, the second generator source breaker, and the fourth source breaker are closed.

In another example, an aspect of the disclosed technology is a power protection system comprising a first source coupled to a first bus through a first source breaker; a second source coupled to a second bus through a second source breaker; a first set of loads coupled to the first bus; a second set of loads coupled to the second bus; and one or more generators coupled to a generator bus through a plurality of generator breakers such that each generator is coupled to the generator bus by a different generator breaker, and wherein a breaker that senses a fault sends a first block to a first neighboring breaker and a second block to a second neighboring breaker.

In accordance with this aspect of the disclosed technology, the system comprises a first breaker and a second breaker, the first breaker and second breaker coupled to each other so as to define a first segment between them, wherein the first breaker senses the fault and sends the first block to the second breaker and a transfer trip to the second breaker based upon receipt of a block from the second breaker. Further, the first breaker trips based on receipt of a block from the second breaker and the second breaker trips in response to receiving the transfer trip. Further still, information indicating that the first breaker and second breaker are tripped is used in determining that the fault occurred on the first segment.

As another example, an aspect of the disclosed technology is a method for locating faults on a power distribution network having a plurality of breakers that can communicate with each other, comprising: sensing, at a first breaker of the plurality of breakers, a fault on the power distribution network; sending, by the first breaker, a first block to a second breaker and a second block to a third breaker of the plurality of breakers, each of the second breaker and the third breaker being coupled to one of two sides of the first breaker; determining, by the first breaker, whether it received a first block from the second breaker and a second block from the third breaker; and tripping, by the first breaker, based on a determination whether it received the first block and the second block.

In accordance with this aspect of the disclosed technology, the method comprises sending, by the first breaker, based on a determination whether the first breaker received the first block from the second breaker, a transfer trip to the second breaker causing the second breaker to trip. The method may also comprise identifying the fault as being located on a segment of the power distribution network based on information indicating that the first and second breakers are tripped. Further still, the second breaker and the third breaker each receive two blocks.

Another aspect of the disclosed technology includes a power protection system, comprising: a first source coupled to a first bus through a first source breaker; a second source coupled to a second bus through a second source breaker; a first set of loads coupled to the first bus; a second set of loads coupled to the second bus; and one or more generators coupled to a generator bus through a plurality of generator breakers such that each generator is coupled to the generator bus by a different generator breaker, the one or more generators being coupled to the first set of loads through respective ones of the plurality generator breakers, a first generator bus breaker (“FA”) and a first bus load breaker (“GA”) and being coupled to the second set of loads through the respective ones of the plurality generator breakers, a second generator bus breaker (“FB”) and a second bus load breaker (“GB”); and wherein the first bus load breaker (“GA”) and the second bus load breaker (“GB”) are configured to communicate using one or more of a health signal, a request to close signal, a request to open signal, a watchdog signal or a breaker status signal.

In accordance with this aspect of the disclosed technology, the health signal and the request to close signal may be used to effect a control scheme in which one of the one or more generators is selected as a preferred source for feeding the first set of loads or the second set of loads. In accordance with this aspect, the health signal, the request to open signal and the request to close signal may be used to effect a control scheme to recover from a loss of either the first source or the second source. In accordance with this aspect, the health signal, the request to open signal and the request to close signal may be used to effect a control scheme to recover from a loss of the first source and the second source. Further in accordance with this aspect, the health signal and the request to open signal may be used to effect a control scheme to in which either the first source or the second source is used to supply the first set of loads and the second set of loads.

### BRIEF DESCRIPTION OF THE DRAWINGS

FIG. 1 shows an example architecture of a power distribution network or system in accordance with an aspect of the disclosed technology.

FIG. 2A shows an example of a protection scheme in accordance with an aspect of the disclosed technology.

FIG. 2B shows an example of a protection scheme in accordance with an aspect of the disclosed technology.

FIG. 3 shows an example of a protection scheme in accordance with an aspect of the disclosed technology.

FIG. 4 is an example of a flow diagram depicting a process of a protection scheme in accordance with an aspect of the disclosed technology.

FIG. 5 shows an example of a control scheme architecture in accordance with an aspect of the disclosed technology.

FIG. 6 shows an example of a breaker in accordance with an aspect of the disclosed technology.

FIG. 7 shows an example of a process flow in accordance with an aspect of the control scheme of the disclosed technology.

FIG. 8 shows an example of a process flow in accordance with an aspect of the control scheme of the disclosed technology.

FIG. 9 shows an example of a process flow in accordance with an aspect of the control scheme of the disclosed technology.

### DETAILED DESCRIPTION

An aspect of the disclosed invention is a protection system or architecture that uses the backup generators bus (or buses) as a tie to supply power to one or more loads in the event that either or both mains become unavailable. For example, assuming power to a facility is supplied by two main sources (e.g., mains A and mains B). If mains A (or conversely mains B) becomes unavailable, the protection and control schemes use the generator bus (referred to as Bus G) to supply power from mains B (mains A) to the loads previously supplied by mains A (mains B). If both mains A and B become unavailable, then Bus G is used to supply power to all loads of the system (e.g., loads previously supplied by mains A and mains B) with power from backup generators.

In the description to follow, the breakers are at times referred to using only their symbol and reference numeral, e.g., GA 136, UB 158, etc., for brevity.

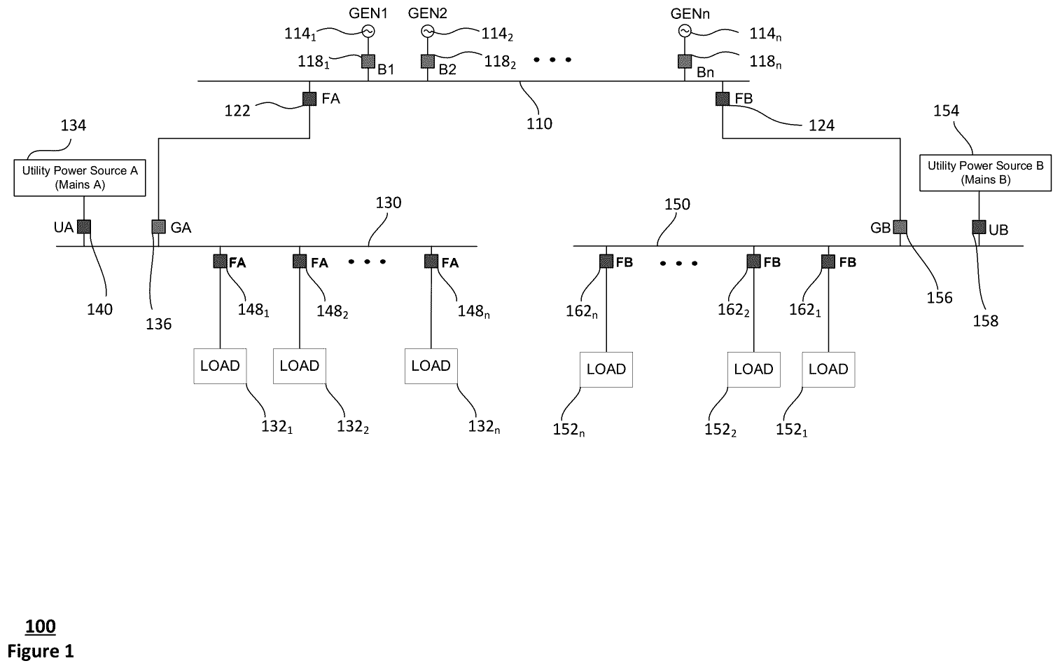

FIG. 1 illustrates an example of a power distribution network or system 100 in accordance with an aspect of the disclosed technology. System 100 includes three buses, Bus G 110, Bus A 130 and Bus B 150. Bus G 110 is a generator bus that is fed by generators 114₁ through 114ₙ and that couples the generators 114 to other parts and elements of system 100. Generators 114₁ through 114ₙ function as back-up power sources supplying the loads of the system in the event that utility power source or mains A 134 and utility power source or mains B 154 become unavailable. Bus G 110 also includes a plurality of generator breakers 118₁ through 118ₙ, as well as line side breakers FA 122 and FB 124. Each generator breaker 118 couples a respective one of generators 114 to Bus G 110.

Bus A 130 is used to feed power to loads 132. Bus A 130 has breakers GA 136 and UA 140, as well as load breakers FA 148₁ through 148ₙ. Load breakers FA 148₁ through 148ₙ may be referred to herein as LFAs 148₁, 148₂, etc., or 148 elsewhere for convenience or clarity. Bus A 130 is coupled to Bus G 110 via breakers GA 136 and FA 122 via cable interconnections. Bus A 130 is coupled to mains A 134 through breaker UA 140. Loads 132 are coupled to Bus A 130 via respective ones of load breakers FA 148.

Bus B 150 is used in feeding power to loads 152. Bus B 150 has breakers GB 156 and UB 158. Bus B 150 also includes load breakers FB 162₁ through 162ₙ. Load breakers FB 162₁ through 162ₙ may be referred to herein as LFBs 162₁, 162₂, etc., or 162 elsewhere for convenience or clarity. Bus B 150 is coupled to Bus G 110 via breakers GB 156 and FB 124 via cable interconnections. Bus B 150 is also coupled to mains B 154 through utility breaker UB 158. Loads 152 are coupled to Bus B 150 via respective ones of load breakers FB 162.

Each breaker is a circuit breaker that operates to protect the circuit formed by the power distribution network from damage from fault current. In effect, each breaker (or circuit breaker) functions as a switch that can open and close to, respectively, prevent and allow the flow of current along a circuit path (e.g., along a cable or line) that includes the breaker. In other words, each circuit breaker is a mechanical mechanism that interrupts current flow. Each circuit breaker is typically controlled by a protective relay that is usually provided separate from the breaker. The circuit breaker and the protective relay operate together to interrupt or open the breaker when a fault, e.g., short circuit or overload, is sensed in the network. The circuit breaker may be an electromechanical switch. The protective relay typically acts as a sensing device that operates to sense or detect faults and sends a signal to the circuit breaker causing it to open for example.

In the example shown, the mains can provide enough power to feed the loads on both Bus A 130 and Bus B 150. The generators are also assumed capable of energizing Bus G 110 with adequate enough power that can be used to feed both Buses A 130 and B 150. Under normal conditions, breakers UA 140, FA 122, FB 124 and UB 158 are closed, while breakers GA 136 and GB 156 are open. In addition, generator breakers 118 are open and the generators 114 are off. As such, Bus G 110 is de-energized and loads 132 are fed by mains A 134 through Bus A 130, while loads 152 are fed by mains B 154 via Bus B 150.

Bus G 110 can be energized (“hot”) by closing either GA 136 or GB 156. In this way, all the loads on the system may be fed by one of mains B or mains A. This may also be considered normal operating conditions. Further, Bus G 110 can also be energized by the generators when an operator selects the generators as a preferred source.

In accordance with the disclosed technology, in the event either mains A or mains B becomes available, Bus G 110 is used in feeding the affected loads on either Bus A 130 or Bus B 150, using the available mains power source, e.g., mains A 134 or B 154, respectively. By using Bus G 110 in this way, it is configured to function as a tie, in a main-tie-main configuration, between Source/Mains A 134 and B 154, to transfer the loads between the power sources. This transfer is effected through appropriate control of the breakers associated with buses G 110, A 130, and B 150. In the event that both source/mains A 134 and B 154 become unavailable, the generators 114 become operable to energize Bus G 110 to feed the loads 132 and 152. The process associated with the communications that take place between different breakers and the sequence in which the breakers open or close in response to different faults is discussed below.

In accordance with this aspect of the disclosed technology, generator Bus G 110 is used as a tie or tie breaker. Using the generator bus as a tie can result in cost savings such as, for example, avoiding the additional expense of a separate and additional tie breaker between the mains. It may also eliminate the need for additional components such as breaker panels and bays. It may also result in a reduction in power and control cabling in the power distribution network.

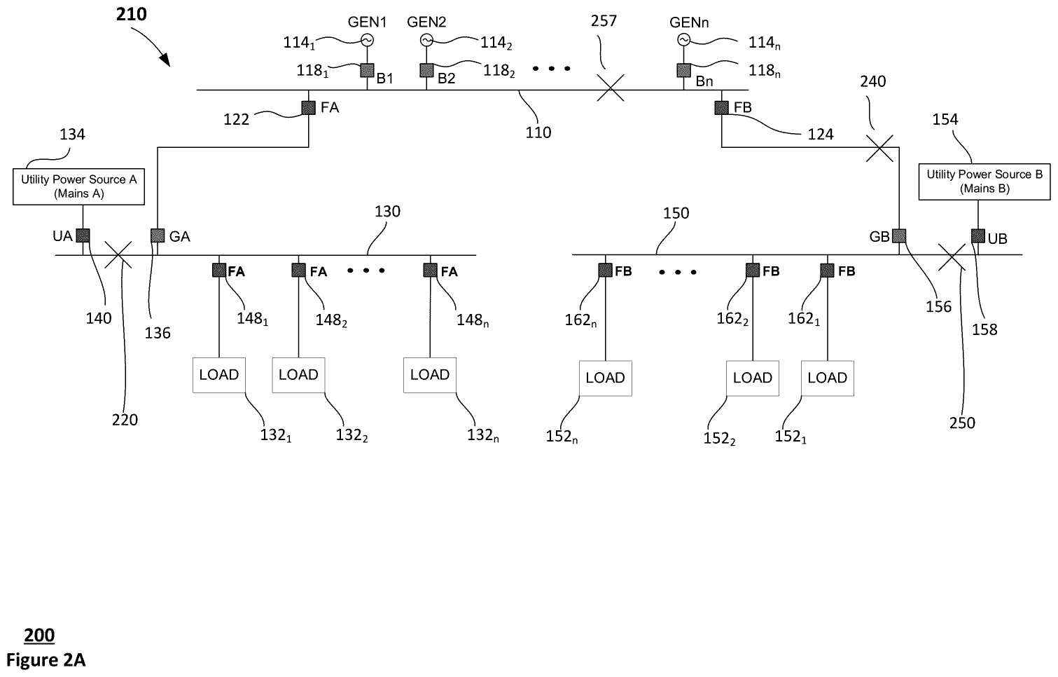

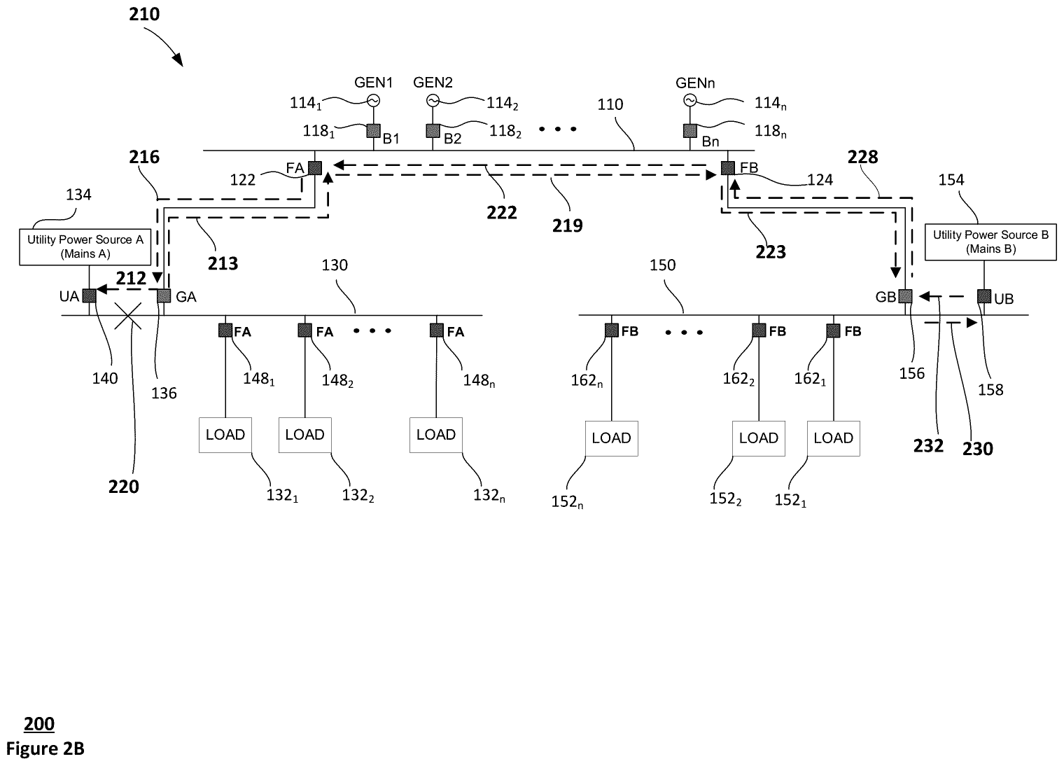

Turning now to FIG. 2A, there is shown an example of a protection scheme 200 in accordance with the disclosed technology. The protection scheme 200 can be used to detect and isolate faults and/or faulty sections of the power distribution system or network 210 shown in FIG. 2A (or any other power distribution architecture employing the various aspects of this disclosure). For example, the protection scheme may be used to detect and isolate faults that occur on the buses or interconnection cables between buses. When the system or network 210 is operating under normal conditions, breakers UA 140, FA 122, FB 124 and UB 158 are configured to be closed, while breakers GA 136 and GB 156 and generator breakers 118 are configured to be open. Further, the generators 114 are configured to be off. In addition, under normal conditions, at least breaker relays GA 136, GB 156, FA 122, and FB 124 can communicate with each other using a communication network indicated by the dashed lines in FIG. 2B. With these breakers configured in this way, loads 132 are fed by mains A 134 through Bus A 130 while loads 152 are fed by mains B 154 via Bus B 150.

In general, in accordance with the protection scheme, when a relay controlling a breaker senses a fault, the relay requires receipt of two blocks in order to not trip—one block from each of its two neighboring breaker relays. A block signal functions to inform a relay to not trip its breaker. If a relay does not receive two blocks, it assumes that the fault is located on the side with the electrical connection from which it did not receive a block and trips its breaker. After the relay trips its breakers, it also sends a transfer trip to the breaker located on the side from which it did not receive the block signal. The protection scheme may be considered a double-block protection scheme in that a breaker will trip only if its breaker relay does not receive two blocks. The double-block scheme is useful in power distribution networks such as those disclosed herein where the loads may be fed from either direction, e.g., from mains A 134 or mains B 154. The breaker that trips can then be used in determining the location of the fault. A breaker relay may sense a fault as a change in power flow or, more generally, as a deviation in current or voltage values from their normal ranges. In response to sensing a fault, a breaker relay will send two blocks (one to each side) to its neighboring breaker relays on the power distribution network.

As discussed above, under normal operating conditions the loads 132, 152 are fed, respectively, by dual utility power sources A 134, B 154. More specifically, GA 136 is open, FA 122 is closed, FB 124 is closed, GB 156 is open, and UA 140 and UB 158 are closed. As such, Bus A 130 is fed through UA 140, while Bus B 150 is fed through UB 158.

Under these conditions, when a fault 220 occurs on Bus A 130, the system 200 operate as follows with reference to FIG. 2A. UA 140 breaker relay detects the fault. Given the location of the fault 220, no other relay, or more specifically no other relay associated with a breaker, senses the fault. As such, UA 140 breaker relay doesn't receive a block from any other breaker relays. UA 140 breaker relay therefore trips its breaker, locks out its breaker, clears the fault, and sends a transfer trip to GA 136 breaker relay, as well as feeder breaker relays LFAs 148. This causes breakers UA 140, GA 136, and all LFAs 148 to trip and lock out. The fault can then be cleared and isolated.

In some instances, utility power source A 134 may not be available and both Bus A 130 and Bus B 150 are supplied by utility power source B 154 via UB 158. In such a case, UA 140 is open, UB 158 is closed. In addition, GA 136, FA 122, FB 124 and GB 156 are also closed. Under these conditions, when a fault 220 occurs at Bus A 130, the system 200 operates as follows with reference to FIG. 2B. The relay associated with breaker GA 136 detects the fault as the power is sourced from the utility power source B 154 through UB 158 and Bus G 110. Once breaker relay GA 136 detects the fault, breaker relay GA 136 sends a block 213 to breaker relay FA 122 and a block 212 to breaker relay UA 140. The breaker relay GA 136 also waits for blocks. The relay GA 136 receives one block 216 from breaker relay FA 122 but doesn't receive any block from either breaker relay UA 140 or relays LFA 148. Therefore, the relay GA 136 trips its breaker, locks it out, and sends a transfer trip to breaker relay UA 140 and all of breaker relays LFA 148. The GA 136 relay sends transfer trips to the breaker relays that it does not receive a block from. UA 140, all LFA breakers are tripped, locked out. In this scenario, FA 122 doesn't trip because FA 122 breaker relay receives a block 222 from breaker relay FB 124 and a block 213 from relay GA 136. Similarly, FB 124 breaker doesn't trip because FB 124 relay receives a block 219 from FA 122 relay and a block 228 from GB 156 relay. GB 156 breaker doesn't trip either because GB 156 relay receives a block 232 from UB 158 relay and a block 223 from FB 124 relay. UB 158 doesn't trip because UB 158 relay receives a block 230 from GB 156 relay. The same protection logic applies to when the system is fed by utility power source A 134.

As another example with reference to FIG. 2B, when a fault 257 occurs on the G-bus 110 with utility source B 154 supplying both Bus A 130 and Bus B 150, i.e., UA 140 is open, UB 158 is closed, and GB 156, FB 124, FA 122, and GA 136 are closed, FB 124 relay detects the fault, sends a block 222 to FA 122 relay and a block 223 to GB 156 relay. FB 124 relay receives a block 228 from GB 156 relay, but doesn't receive any block from FA 122 relay because the relay of FA 122 doesn't sense any fault. FB 124 relay trips its breaker, locks it out, sends a transfer trip to FA 122 relay. The relay FB 124 sends a transfer trip to FA 122 relay because the relay FB 124 doesn't receive a block from FA 122 relay. FA 122 and FB 124 trip their breakers, locking them out. In this scenario, GB 156 doesn't trip because GB 156 relay receives a block 223 from FB 124 relay and a block 232 from UB 158. UB 158 doesn't trip because its relay receives a block 230 from GB 156 relay.

As another example, with Buses A 130 and B 150 being supplied by utility source B 154, if a fault occurs on cable between FB 124 and GB 156 (as shown by 240 in FIG. 2A for clarity but would be in the same location on FIG. 2B) the system operates as follows. In this scenario, GB 156 relay detects the fault and sends a block 228 to FB 124 relay and a block 230 to UB 158 (as shown, for example, in FIG. 2B). GB 156 relay receives a block 232 from UB 158 relay, but doesn't receive a second block from FB 124 relay because FB 124 relay doesn't sense the fault. GB 156 relay trips its breaker and locks it out. GB 156 sends a transfer trip to FB 124 relay. FB 124 trips its breaker and locks it out. The fault is cleared and isolated.

In keeping with the example where utility source B 154 supplies both Bus A 130 and Bus B 150, when a fault occurs on Bus B 150 between GB 156 and UB 158 (as shown by 250 in FIG. 2A), the relay of UB 158 detects the fault. UB 158 doesn't receive any block, therefore, UB 158 trips its breaker, locks it out and sends a transfer trip to GB 156 and LFB 162 relays. GB 156 and LFB 162 relays trip their breakers and lock them out.

As another example, and with reference to FIG. 2A, the system 200 is operating in a state where power is supplied by generators 114 as a result of a dual loss of utility power sources A 134 and B 154. Under these conditions, breaker UA 140 and breaker UB 158 are open, while breakers FA 122, FB 124, GA 136 and GB 156 are closed. When there is a Bus G 110 fault (see fault 257 in FIG. 2A), all the relays of the generator breakers 118 sense the fault, the generator 114 relays wait for a block. Since neither relay in either FA 122 or FB 124 sense the fault, FA 122 and FB 124 relays do not send any blocks. All the generator relays trip their breakers 118, lock them out, and send transfer trips to FA 122, FB 124 and all others generator relays. FA 122 and FB 124 trip their breakers, and lock them out. All the generator relays trip their breakers which are already tripped and locked out.

With the system being supplied by the generators 114, if a fault occurs between FA 122 and GA 136, FA 122 relay detects the fault, sends a block to all the relays of generator breakers 118, breaker FB 124, and GA 136. The relay of FA 122 receives a block from the relays of the generator breakers 118 but doesn't receive a second block from GA 136 relay, therefore FA 122 trips its breaker, locks it out, and sends a transfer trip to GA 136 relay. All the relays of the generator breakers 118 also sense the fault, but they receive a block from the relay of breaker FA 122, therefore the relays of the generator breakers 118 do not trip their breakers. When the power is being supplied by generators 114 and a fault occurs between FB 124 and GB 156, the protection logic is similar to a fault that occurs between FA 122 and GA 136.

With the system being supplied by the generators 114, if a fault occurs on Bus A 130, (see fault 220 in FIG. 2A), GA 136 relay detects the fault, sends a block to FA 122 relay. GA 136 trips its breaker, locks it out, and sends a transfer trip to UA 140, as well as all LFA 148 relays. UA 140 and the LFA 148 relays trip their breakers and lock them out. The relay of FA 122 also senses the fault, but receives a block from the relays of the generator breakers 118 and breaker GA 136, therefore, breaker FA 122 refrains from tripping.

As can be seen from FIG. 2B, breakers FA 122, FB 124 and GB 156 each receive two blocks. However, breaker GA 136 receives only one block and therefore trips. In addition to tripping, GA 136 will also send a transfer trip to breaker UA 140 as it did not receive a from block UA 140, which did not sense the fault. The transfer trip will cause UA 140 to trip. By tripping, GA 136 provides an indication that the fault is associated with one of the electrical connections to GA 136. Further, because UA 140 also trips, this provides an indication that the fault is between the two tripped breakers GA 136 and UA 140. With the fault isolated, the system can then be repaired.

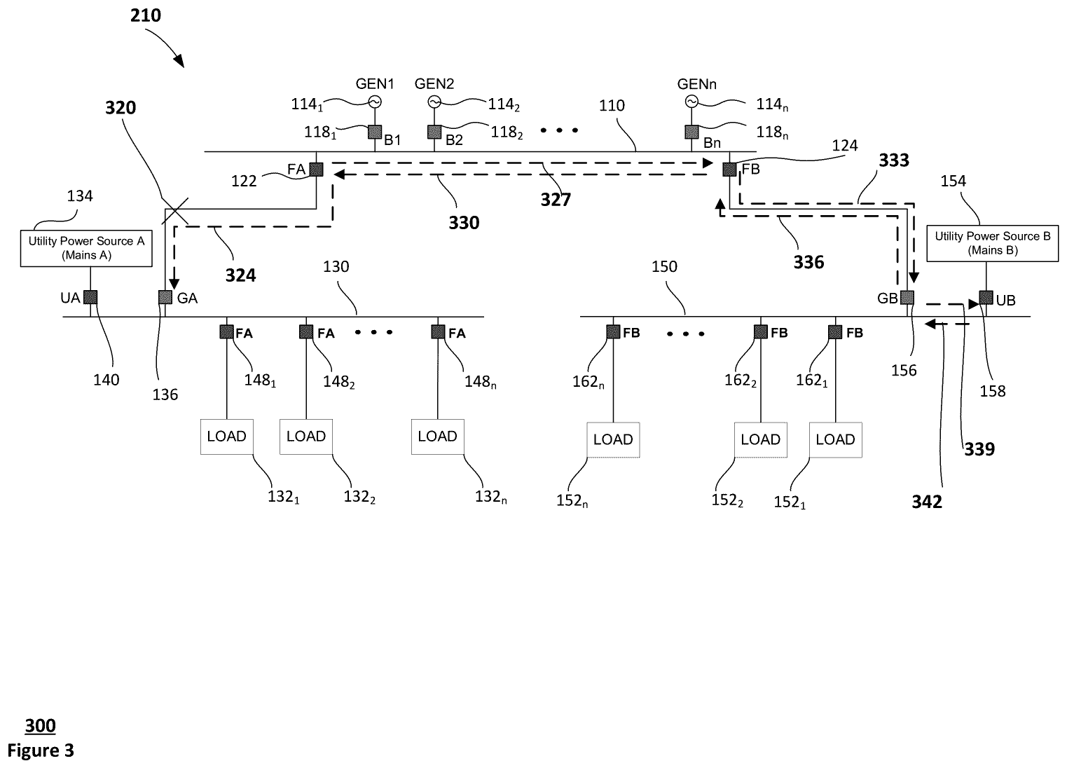

In another example of the protection scheme, a fault 320 occurs on the cabling or line between FA 122 and GA 136 as shown in FIG. 3. FA 122 senses fault 320 based on sensing an increase in power or current flow from the direction of mains B. In response to sensing the fault, FA 122 sends two blocks—one to GA 136 and another to FB 124. As shown, block 324 is sent to GA 136 while block 327 is sent to FB 124. FB 124 senses the fault and sends a block 330 to FA 122 and a block 333 to GB 156. GB 156 also senses the fault and sends a block 336 to FB 124 and a block 339 to UB 158. UB 158 also senses the fault and sends a block 342 to GB 156. GA 136 does not sense the fault because all the current or power flows to the fault. Since GA 136 does not sense the fault it therefore does not send any blocks. Similarly, UA 140 does not sense the fault and does not send any blocks.

As indicated in FIG. 3, of the breakers that sensed the fault and have two neighboring breakers, only breaker FA 122 did not receive two blocks. FA 122 only received a block 330 from FB 124. In contrast, breakers FB 124 and GB 156 each received two blocks. As such, breaker FA 122 will trip and send a transfer trip to GA 136. Further, FB 124 and GB 156 will not trip because they each received two blocks. Because FA 122 trips, it provides an indication that the fault is associated with a line or cable it is connected to. Further, because it sends a transfer trip to breaker GA 136 causing it to trip, only breakers FA 122 and GA 136 trip. This provides an indication that the fault is between FA 122 and GA 136.

In another example and with reference to FIG. 3, instead of the fault being between FA 122 and GA 136, the fault occurs between FB 124 and GB 156. GB 156 will sense the fault and send blocks to FB 124 and UB 158. UB 158 will also sense the fault and send a block to GB 156. Since FB 124 does not sense the fault, it does not send any blocks. Accordingly, GB 156 receives only a single block. GB 156 therefore trips and sends a transfer trip to FB 124, which causes it to trip. The fault is therefore located between FB 124 and GB 136.

In accordance with the protection scheme, for each segment (FA 122—GA 136, FA 122—FB 124, and FB 124—GB 156), if a relay does not receive a block from one side (e.g., one of its neighboring breakers), the relay trips its breakers and sends a transfer trip to the side from which it did not receive a block. For example, FB 124 senses a fault but it does not receive a block from FA 122, then the fault is on the generator Bus G 110 (segment FA 122—FB 124). If FB 124 does not receive a block from GB 156, then the fault is on segment FB 124—GB 156.

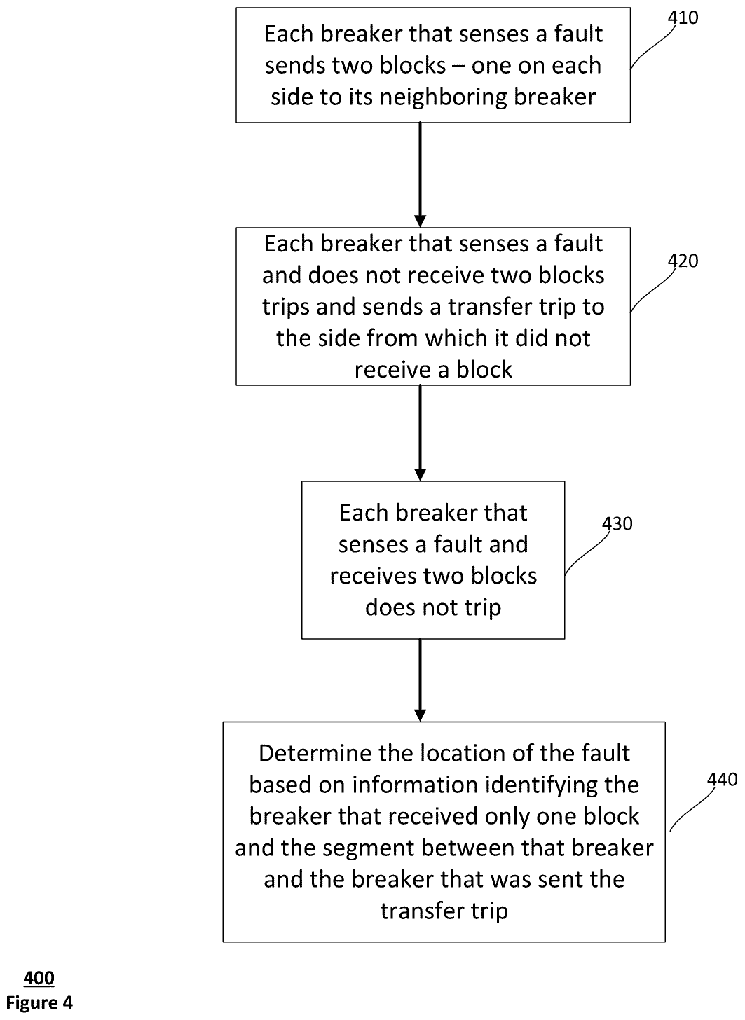

FIG. 4 is a flow diagram 400 that depicts, in general, the process of the protection scheme. As discussed in the examples above, the process is triggered when a fault is sensed on the power distribution network or system. When a fault occurs, it may be sensed by one or more breaker relays. As indicated at block 410, each breaker relay that senses the fault responds by sending two blocks—one on each side to its neighboring breaker. Accordingly, each breaker relay that is connected to two breakers (one breaker on each side) should receive two blocks if both of its neighbors' relays sense the fault.

As indicated at block 420 each breaker relay that senses a fault and does not receive two blocks trips its breaker and sends a transfer trip to the side from which it did not receive a block. In this way, the breaker on the side that it did not receive a block from, will also trip. In contrast, as indicated at block 430, each breaker relay that senses a fault and receives two blocks does not trip. Accordingly, in accordance with this process, only two breakers should trip.

At block 440, the location of the fault can be determined based on information identifying the breaker that received only one block and the breaker that received the transfer trip. More specifically, the segment between these breakers may be determined as the segment on which the fault is located.

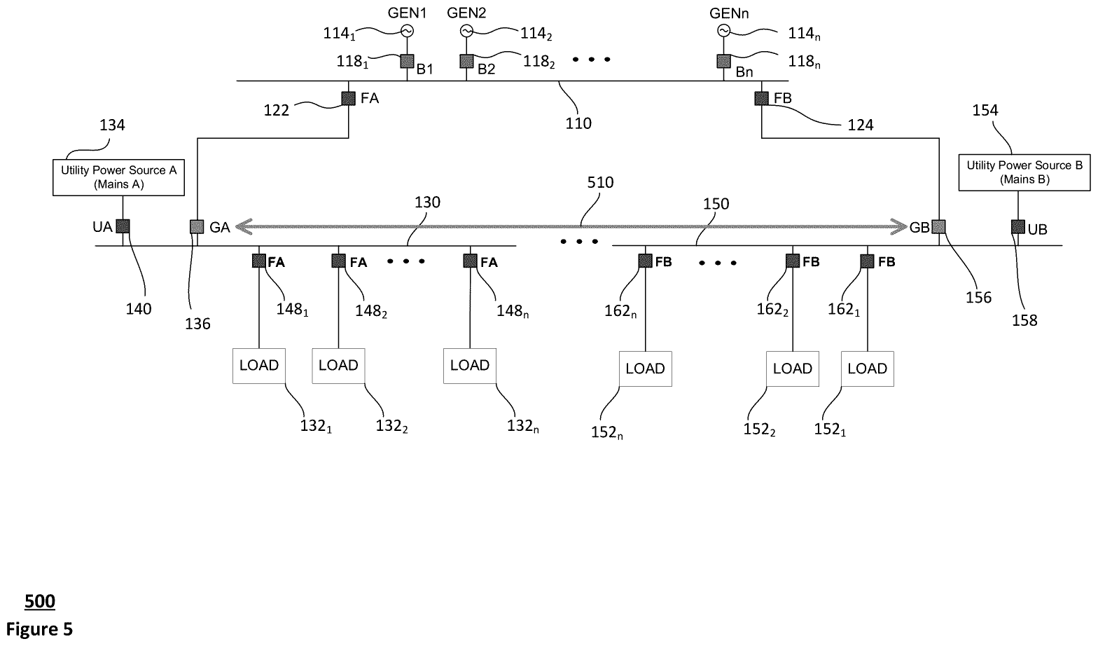

Turning now to FIG. 5, there is shown a power distribution network 500 implementing a control scheme in accordance with an aspect of the disclosed technology. The control scheme is used in configuring the generator bus, Bus G 110, to operate as a tie. In general, the transfer control scheme specifies a methodology for reconfiguring the breakers to allow for different modes of operations to meet operational and maintenance requirements. For instance, the control scheme can be used to control energization of the buses in the event of failures, faults, or more generally, abnormal conditions occurring on the network. The scheme also allows local or remote (e.g., via Human Machine Interface) user/operator action to reconfigure the power feeding to the loads on the network to, for example, a preferred source.

The control scheme includes exchange of one or more signals or messages between breaker GA 136 and breaker GB 156 as represented by communication medium 510. Communication medium 510 includes the wire or cables connecting breaker relays GA 136 and GB 156, and may also include other ancillary devices, e.g., routers, switches, etc., needed to facilitate communications between the breaker relays. Examples of communication medium 510 include telephone wires, digital cables, or optical cables and ancillary devices. The breakers will typically include one or more interfaces that support various communications and protocols including the Internet, World Wide Web, intranets, virtual private networks, wide area networks, local networks, private networks using communication protocols, point-to-point communications, or international standard defining communication protocols, hard-wired, Ethernet, WiFi, RPC, HTTP, and various combinations of the foregoing.

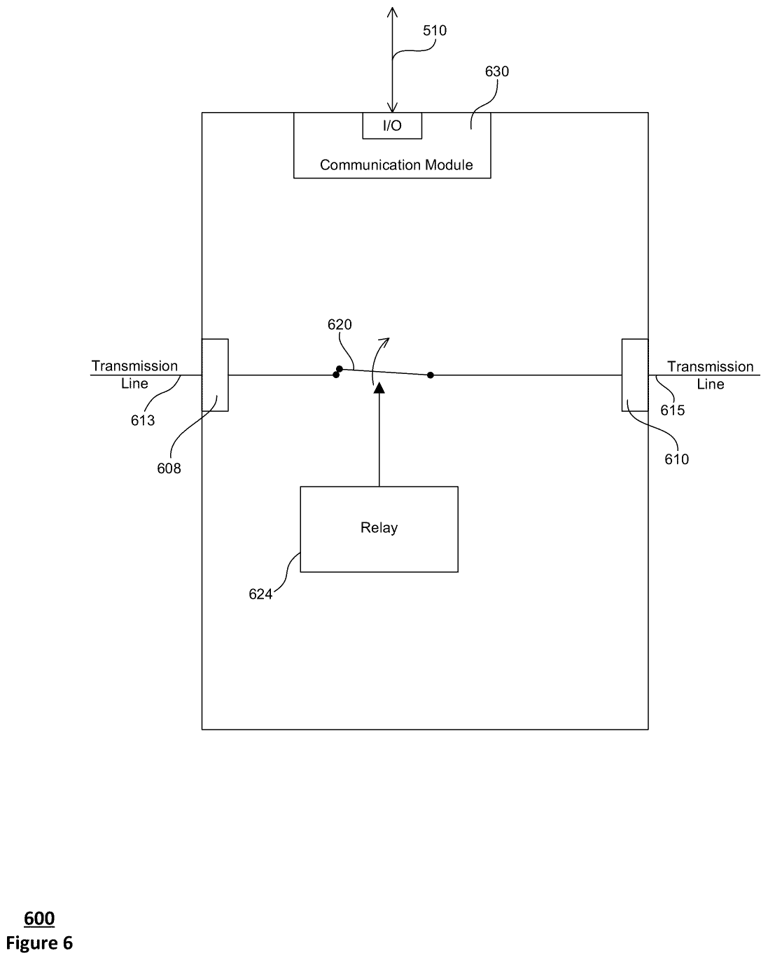

FIG. 6 shows an example apparatus 600 that may be implemented as breakers GA 136 and GB 156, as well as the other breakers on the power distribution network described herein. As shown, apparatus 600 includes connections 608, 610 to power lines 613, 615 on either side of the device. Each power line 613, 615 carries the power destined for loads supported by the power distribution network. Each power line 613, 615 connects apparatus 600 to one or more neighboring breakers, which may be implemented as apparatus 600 or some other configuration that includes a breaker and relay in accordance with the disclosed technology, as shown in the power distribution networks discussed above.

As shown, apparatus 600 includes a breaker 620 operable to open (trip) in response to a signal provided by relay 624. When breaker 620 is closed, current flows between power lines 613, 615. Breaker 620 is typically an electromechanical switch. Relay 624 detects or senses faults on the power lines 613, 615, via lines 630, 634 and triggers the switch or relay breaker 620 to open. Relay 624 can also communicate with other relays via communication mediums or communication interfaces that may include various configurations and protocols, including the Internet, World Wide Web, intranets, virtual private networks, wide area networks, local networks, private networks using communication protocols, point-to-point communications, or international standard defining communication protocols, hard-wired, Ethernet, WiFi, RPC, HTTP, and various combinations of the foregoing.

Apparatus 600 also includes a communication module 630 that is coupled to communication medium 510. Communication module 630 is configured to transmit and receive signals via communication medium 510. In accordance with the disclosed technology, the signals form a set of status indicators and control signals associated with apparatus 600 that are exchanged with other apparatus or relays associated with breakers. Accordingly, the signals may take the form of data that informs one relay of apparatus 600 as to the status of another.

Returning to FIG. 5, relays associated with breakers GA 136 and GB 156 are configured to exchange status signals over communication medium 510 via, for example, respective communication modules 630 in accordance with the protection scheme of the disclosed technology. The status and control signals include:
a. A Health Signal from GA 136 to GB 156
b. A Health Signal from GB 156 to GA 136
c. A Request to Close from GA 136 to GB 156
d. A Request to Close from GB 156 to GA 136
e. Request to Open Signal from GA 136 to GB 156
f. Request to Open Signal from GB 156 to GA 136
g. GA 136 Watchdog Signal to GB 156 or GA 136 Breaker Status to GB 156 (For Relay Failure cases)
h. GB 156 Watchdog Signal to GA 136 or GB 156 Breaker Status to GA 136 (For Relay Failure cases)
   The Health Signal provides an indication of “Normally Open Contact” and consists of the following attributes:
1. A Gx breaker (e.g., GA 136 or GB 156) is Open (positive confirmation)
2. A Gx breaker Close Interlocks are Healthy
3. A Gx breaker is in Auto Mode
4. Respective Bus VT is Healthy or Respective Utility VT is healthy.

The modes of operation of the system of FIG. 5 include:
Typical Mode of Operation: Bus A 130 is fed by UA 140 and Bus B 150 is fed by UB 158.
Single Source Mode: A single source feeds both Bus A 130 and Bus B 150. This mode thus includes UA 140 feeding both Bus A 130 and Bus B 150 or UB 156 feeding both Bus A 130 and Bus B 150.
Generator Source Mode: One or more of generators 114 feed the entire system.
GPS Bus Tie Mode: The GPS bus, e.g., Bus G 110, is selected as the hot tie.

The above status and control signals may be communicated as digital data in implementing the communication scheme. For example, each signal may occupy a bit position in a data byte, where a “1” or “0” value conveys the status or request of a given breaker.

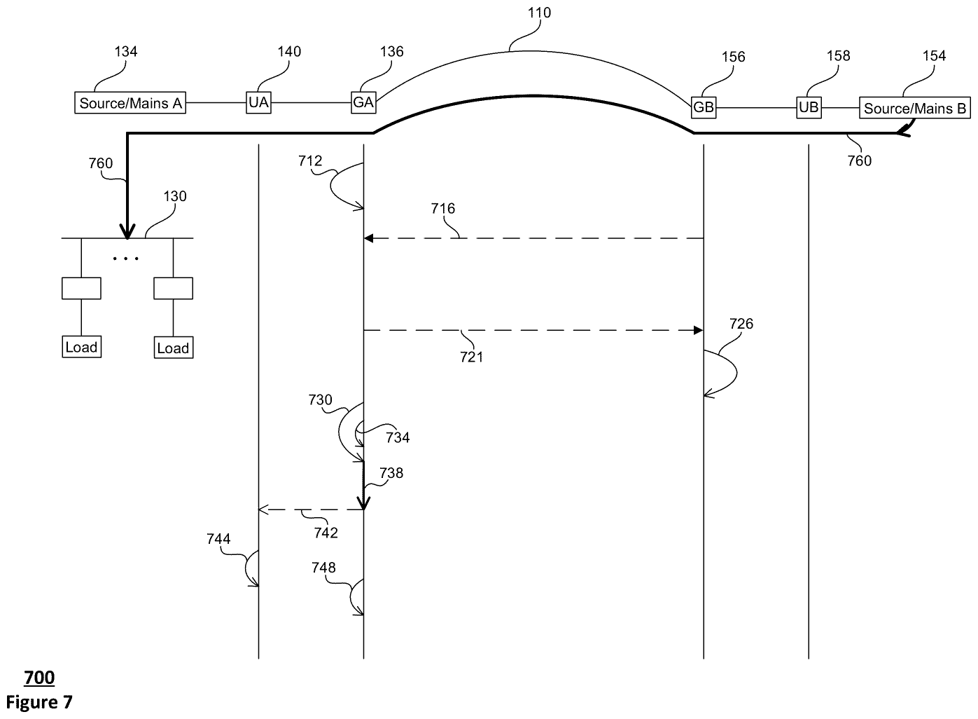

In one example, the control scheme implemented by network 500 functions to automatically use the generator bus, Bus G 110, as a tie in response to the loss of a utility power source or mains. For instance, with reference to FIGS. 5 and 7, and assuming that under normal operating conditions, breakers UA 140, FA 122, FB 124, and UB 158 are configured to be closed, while breakers GA 136 and GB 156 and generator breakers 118 are configured to be open, the scheme operates as follows if mains A 134 is lost.

First, GA 136 will automatically sense or detect a loss of voltage on Bus A 130, as depicted by loop 712 in FIG. 7. GA 136 will then check that it is receiving a Health Signal from GB 156, as depicted by communication line 716. The receipt of the Health Signal from GB 156 provides an indication that the power source for Bus B 150, i.e., mains B, is healthy and GB 156 can be closed. GA 136 therefore sends a Request to Close signal to GB 156, as depicted by communication line 721. In this regard, GA 136 would not send a Request to Close signal until either GA 136 or UA 140 is open.

When GB 156 receives the Request to Close, GB 156 attempts to close provided its Health Signal still provides an indication that it is healthy (e.g., GB 156 Health Signal is still high), as depicted by loop 726. When GB 156 closes, Bus G 110 will energize and GA 136 will start detecting that it has a healthy line side voltage, as depicted by loop 730. GA 136 will also start a timer that operates to ensure that the line voltage is stable, as depicted by loop 734. When the timer expires, GA 136 determines that it has a healthy line side voltage, as depicted by line 738. GA 136 will then send an Open Command to UA 140, as depicted by communication line 742. Once UA 140 opens, GA 136 closes—as depicted respectively by loops 744 and 748. In this way, Bus A 130 is supplied by utility power source or mains B 154, as depicted by power transmission path 760.

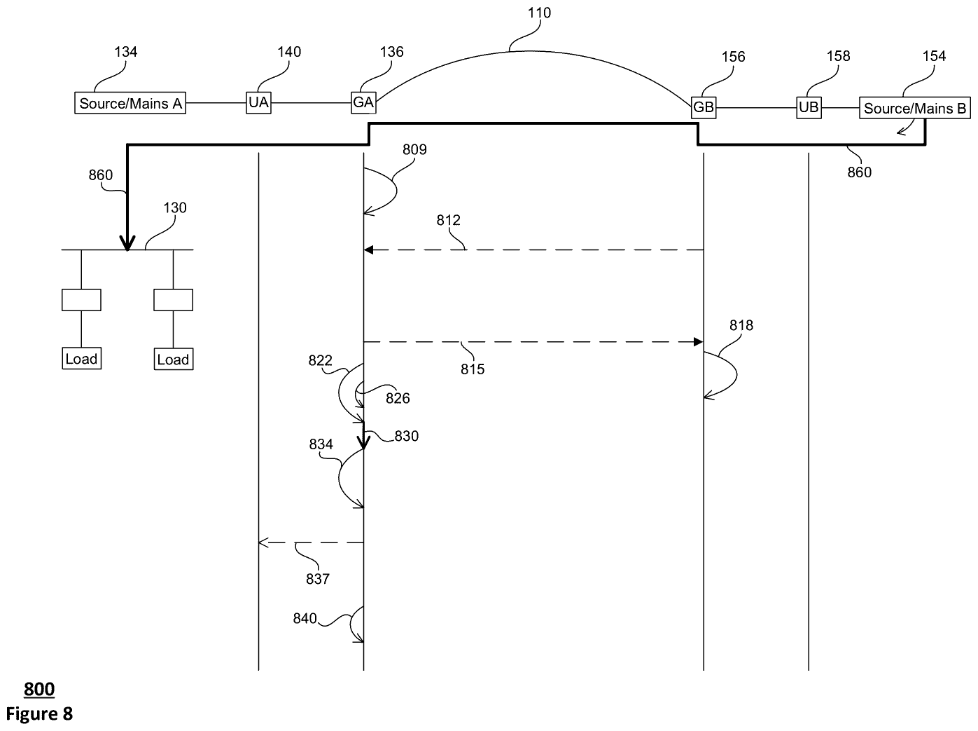

Turning now to FIG. 8, an example of a process flow 800 of the control scheme is depicted in with accordance an aspect of the disclosed technology. In accordance with this aspect of the disclosed technology, each load bus breaker panel, e.g., GA 136 and GB 156 panels, includes a center return switch with governs enabling Bus G 110 to operate as a tie or, alternatively or in addition, Bus G 110 may also be so enabled via a soft switch available via a Human Machine Interface (“HMI”). GA 136 determines whether it is receiving a Health Signal from GB 156, which is depicted via communication line 812. Receipt of the Health Signal from GB 156 provides an indication that Bus B 150 has a healthy utility voltage supplied via source/mains B 154.

The process 800 is initiated when GA 136 detects activation of a center return switch or soft switch to the “ON” position, for example. Specifically, as depicted by loop 809, GA 136 detects activation of a center switch or soft switch, e.g., by sensing a voltage change associated with a center switch or soft switch changing to the “ON” position.

GA 136 then sends a request to close to GB 156, as depicted by communication line 815. Note that load breakers GA 136 or GB 156 typically will not send a Request to Close signal until that breaker or its respective utility breaker, respectively UA 140 or UB 158, is open. Further, note that in accordance with this process 800, if GA 136 is already closed it will send an open command to UA 140 to fulfill the condition that either UA 140 or GA 136 is open before GA 136 sends a request to close GB 156.

When GB 156 receives the request to close, it attempts to close, provided its Health Signal indicates source/mains B is still healthy, as depicted at loop 818. Bus G 110 will then energize, which will be detected or sensed by GA 136 on its line side, which is depicted as loop 822. GA 136 will also start a timer that operates to ensure that the line voltage is stable, as depicted by loop 826. When the timer expires, GA 136 determines that it has a healthy line side voltage, as depicted by line 830. In the event source/mains A is lost, GA 136 will detect it, as indicated by loop 834, and send an open command to UA 140, as depicted by communication line 837. In addition, GA 136 will then close, as depicted by loop 840. Source/mains B 154 can then power Bus A 130 via transmission path 860.

In accordance with the process 800, source/mains B may function as a hot standby. This avoids potential delays associated with tie over source/mains B only after source/mains A is lost.

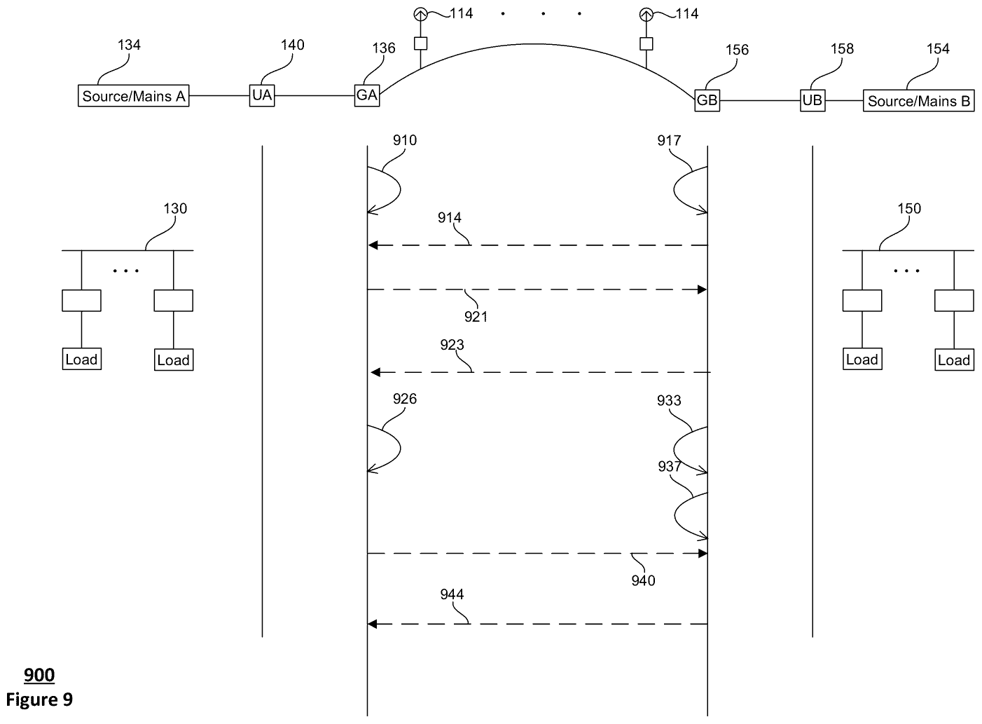

Turning now to FIG. 9, an example of a process flow 900 of the control scheme is depicted in accordance with an aspect of the disclosed technology. Process flow 900 corresponds to a condition where both sources/mains A and B, 134/154, are unavailable. At the outset, the breakers in FIG. 9 are set as follows: UB 158 is closed, GB 156 is closed, GA 136 is closed and UA 140 is open. In accordance with the process 900, the generators will start in accordance with the following logic:
1. Loss of Utility A (Normally Close Held Open Contact) AND (In Series with) (GA Open (Normally Close Contact) OR (In Parallel with) UA Open (Normally Close Contact).
2. Loss of Utility B (Normally Close Held Open Contact) AND (In Series with) (GB Open (Normally Close Contact) OR (In Parallel with) UB Open (Normally Close Contact).
3. Generator Start Command During Dual Loss of Source will be Generated by 2 AND (In Series with) 3.
   The foregoing logic may be hardwired at the generator cabinet and function as part of the Generator Start Command.

In accordance with the process 900, GA 136 detects that Bus A 130 is not healthy because of a lack of power from source/mains A, as indicated at loop 910. In addition, GA 136 will receive an indication from GB 156 that it is not healthy, as indicated by communication line 914. Similarly, GB 156 detects that Bus B 150 is not healthy because of a lack of power from source/mains B, as indicated at loop 917. In addition, GB 156 will receive an indication from GA 136 that it is not healthy, as indicated by communication line 921.

GA 136 will wait for a Request to Open Time Delay in which it will receive a Request to Open from GB 156, as indicated by loop 926. GA 136 or GB 156 sends a request to open when its respective bus voltage is not present and corresponding GA 136 or GB 156 Health Signal is low. When GA 136 receives the Request to Open from GB 156 (as indicated by communication line 923), it will open UA 140 (if UA 140 is not already open) as indicated via loop 926. GB 156 will perform the same actions simultaneously with GA 136, as indicated by loop 933. GB 156 will detect its respective bus voltage (SSSB), e.g., voltage on Bus B 150, as not healthy. GB 156 will also see GA 136's Health Signal as low. GB 156 will then wait for the Request to Open Time Delay (as indicated by loop 937) in which it will receive request to open from GA 136. When GB 156 receives the Request to Open from GA 136 (as indicated by communication line 940) it will open GB 156 (if GB 156 is not already open). Once GA 136 receives the request to Open Time Delay from GB 156 (as indicated by communication line 944) and opens UA 140, GA 136 will detect its respective bus voltage SSSA, e.g., voltage on Bus A 130 is not healthy and a Generator Start command will be initiated to the generator controller.

In accordance with a further aspect of the disclosed technology, the control scheme may be used in implementing operations where an operator selects the generator as the preferred source for feeding the system. With reference to FIG. 5, this control scheme may be implemented as follows:
1. As a first step, an operation is initiated which causes the generator (e.g., one or more of 114) to be selected as the preferred source. For example, an SSSA Operator may select the preferred source as generator.
2. Once GA 136 and GB 156 open, a Preferred Generator Start Signal is communicated to the generator controller.
3. The generator controller will then cause the generators to start and synchronize on GPS Bus 110.
4. GA 136 will see Generator Healthy Voltage at its Line Side.
5. When GA 136 Source Healthy Time Delay expires, GA 136 will determine it has a Healthy Line Source.
6. If GA 136 is preferred, it will initiate the Transfer.
7. GA 136 will send an Open command to UA 140 and then UA 140 will Close itself.

In accordance with a further aspect of the disclosed technology, the control scheme may be used in implementing operations where the UA 140 source 134 at Bus A 130 is lost, e.g., a single loss of source case. With reference to FIG. 5, this control scheme may be implemented as follows:
1. GA 136 will detect Loss of Bus A 130 Voltage (Automatic Trigger).
2. GA 136 is receiving a Health Signal from GB 156, which essentially translates into that Bus B 150 has Healthy Utility Voltage and GB 156 can be closed.
3. GA 136 sends request to Close to GB 156. (Note Gx will not send Request to Close Signal until either Gx or its respective Utility Breaker Ux is Open).
4. Note that if GA 136 is already Closed, it will send an Open Command to UA 140.
5. When GB 156 receives a request to Close, GB 156 attempts to Close, provided GB 156's Health Signal is still High.
6. Now GPS Bus 110 will energize and GA 136 will start seeing Line Side Voltage.
7. When GA 136 Source Healthy Time Delay expires, GA 136 will determine that it has a Healthy Line Side Voltage.
8. GA 136 will send an Open Command to UA 140; once UA 140 Opens, GA 136 will close.

In accordance with a further aspect of the disclosed technology, the control scheme may be used in implementing operations in a generator start, dual loss of source scenario. In this scenario, the initial condition is that UA 140 and UB 158 are functioning as feeders and suddenly both sources are lost. With reference to FIG. 5, this control scheme may be implemented as follows:
1. Loss of source A 134 AND (GA 136 Open OR UA 140 Open) indicates source of utility A 134 has lost.
2. Loss of source B 154 AND (GB156 Open OR UB 158 Open) indicates source of utility B 154 has lost.
3. Point 2 above will be TRUE and Gen Start Command will be initiated/sent to the generator controllers.
4. Generators will start and will energize GPS Bus 110 by closing their breakers.
5. When GA 136 Source Healthy Time Delay expires, GA 136 will determine that it has Healthy Line Side Voltage.
6. GA 136 will send an Open Command to UA 140. Once UA 140 Opens, GA 136 will close.
7. GB 156 will do the same; that is, when GB 156 Source Healthy Time Delay expires, GB 156 will determine that it has Healthy Line Side Voltage.
8. GB 156 will send Open Command to UB 158; once UB 158 Opens, GB 156 will close.

In accordance with a further aspect of the disclosed technology, the control scheme may be used in implementing operations in single source mode, e.g., where Power Source B 154 is selected as the preferred source. With reference to FIG. 5, this control scheme may be implemented as follows:
1. GA 136 is receiving a Health Signal from GB 156 which essentially translates into that Bus B 150 has Healthy Utility Voltage and GB 156 can be closed.
2. GA 136 sends a request to Close to GB 156. (Please note Gx will not send a Request to Close Signal until either Gx or its respective Utility Breaker Ux is Open).
3. When GB 156 receives a request to Close, GB 156 attempts to Close provided GB 156's Health Signal is still High.
4. Now GPS Bus 110 will energize and GA 136 will start seeing Line Side Voltage.
5. When GA 136 Source Healthy Time Delay expires, GA 136 will determine that it has Healthy Line Side Voltage.
6. GA 136 will send an Open Command to UA 140, Once UA 140 Opens, GA 136 will close.

In accordance with a further aspect of the disclosed technology, the control scheme may be used in implementing operations in single source mode and there is a single loss of source, e.g., Power Source 154 is the preferred source and it is lost. With reference to FIG. 5, this control scheme may be implemented as follows:
1. GA 136 will see its respective Bus Voltage Not Healthy as UA 140 is open.
2. GA 136 will also see GB 156's Healthy Signal Low.
3. GA 136 will send a Request to Open to GB 156.
4. GB 156 will wait for Request to Open Time Delay in which it will receive a Request to Open from GA 136 (Request to Open is sent by Gx when its Respective Bus Voltage is not present and corresponding Gx Health Signal is Low).
5. When GB 156 receives a Request to Open from GA 136, GB 156 will Open UB 158 (if UB 158 is not already Open).
6. GB 156 is receiving a Health Signal from GA 136 which essentially translates into that Bus A 130 has Healthy Utility Voltage and GA 136 can be closed.
7. GA 136 sends a request to Close to GB 156. (Please note Gx will not send Request to Close Signal until either Gx or its respective Utility Breaker Ux is Open).
8. If GA 136 is already Closed, it will send a Close Command to UA 140 upon receiving a Request to Close.
9. When GA 136 receives a request to Close, GA 136 attempts to Close UA 140 provided GA 136's Health Signal is still High.
10. Now UA 140 will close and both Bus A 130 and Bus B 150 will energize from UA 140.

In accordance with a further aspect of the disclosed technology, the control scheme may be used in implementing operations where the GPS bus 110 functions like a hot tie, e.g., GPS bus is always hot. With reference to FIG. 5, this control scheme may be implemented as follows:
1. For this example, the GPS HOT B Mode is selected.
2. GA 136 is receiving a Health Signal from GB 156 which essentially translates into that Bus B 150 has healthy Utility Voltage and GB 156 can be closed.
3. GA 136 sends a request to Close to GB 156. (Please note Gx will not send a Request to Close Signal until either Gx or its respective Utility Breaker Ux is Open).
4. Please note that if GA 136 is already Closed, GA 136 will Self-Open.
5. When GB 156 receives a request to Close, GB 156 attempts to Close, provided GB 156's Health Signal is still High.
6. Now GPS Bus 110 will energize and GA 136 will start seeing Line Side Voltage.
7. When GA 136 Source Healthy Time Delay expires, GA 136 will determine it has Healthy Line Source.
8. Only when UA 140 Source is Lost, GA 136 will send an Open command to UA 140 and Close Self.
9. Please note, a Request to Close signal will be the only means by which Gx can Close if the corresponding Ux is Open.

Although the technology herein has been described with reference to particular examples, it is to be understood that these examples are merely illustrative of the principles and applications of the Present technology. It is, therefore, to be understood that numerous modifications may be made to the illustrative examples and that other arrangements may be devised without departing from the spirit and scope of the present technology as defined by the appended claims. For instance, although the example operations are shown using certain components of the power system architectures it should be understood similar operations may be performed by similar components of the power system architectures.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including,” and the like, should not be interpreted as limiting the subject matter of the claims to the specific examples; rather, the examples are intended to illustrate only one of many possible other examples. Further, the same reference numbers in different drawings can identify the same or similar elements.

1. A power distribution system, comprising
a first source coupled to a first bus through a first source breaker;
a second source coupled to a second bus through a second source breaker;
one or more generators coupled to a generator bus through a plurality of generator breakers such that each generator is coupled to the generator bus by a different generator breaker;
a first set of loads coupled to the first bus; and
a second set of loads coupled to the second bus; and
wherein the generator bus operates as a tie used in providing power from the second source to the first set of loads when the first source is unavailable or as a tie used in providing power from the first source to the second set of loads when the second source is unavailable.

2. The power distribution system of claim 1, comprising a first generator bus breaker and a third source breaker coupled between the generator bus and the first bus.

3. The power distribution system of claim 2, comprising a second generator bus breaker and a fourth source breaker coupled between the generator bus and the second bus.

4. The power distribution system of claim 3, wherein when the generator bus is used as the tie in providing power from the second source to the first set of loads when the first source is unavailable, the first source breaker is open and the third source breaker, the first generator bus breaker, the second generator bus breaker, the fourth source breaker, and the second source breaker are closed.

5. The power distribution system of claim 3, wherein when the generator bus is used as the tie in providing power from the first source to the second set of loads when the second source is unavailable, the second source breaker is open and the third source breaker, the first generator bus breaker, the second generator bus breaker, the fourth source breaker, and the first source breaker are closed.

6. The power distribution system of claim 3, wherein the generator bus operates to provide power from the one or more generators when the first source and second source are unavailable.

7. The power distribution system of claim 6, wherein when the generator bus operates as a backup bus used in providing power from the one or more generators when the first and second source breakers are opened and the third source breaker, the first generator bus breaker, the second generator bus breaker, and the fourth source breaker are closed.

8. A power protection system, comprising:
a first source coupled to a first bus through a first source breaker;
a second source coupled to a second bus through a second source breaker;
a first set of loads coupled to the first bus;
a second set of loads coupled to the second bus; and
one or more generators coupled to a generator bus through a plurality of generator breakers such that each generator is coupled to the generator bus by a different generator breaker; and
wherein a breaker that senses a fault sends a first block to a first neighboring breaker and a second block to a second neighboring breaker.

9. The power protection system of claim 8, comprising a first breaker and a second breaker, the first breaker and second breaker coupled to each other so as to define a first segment between them, wherein the first breaker senses the fault and sends the first block to the second breaker and a transfer trip to the second breaker based upon a determination whether a block is received from the second breaker.

10. The power protection system of claim 9, wherein the first breaker trips based upon the determination whether the block is received from the second breaker and the second breaker trips in response to receiving the transfer trip.

11. The power protection system of claim 10, wherein information indicating that the first breaker and second breaker have tripped is used in determining that the fault occurred on the first segment.

12. A method for locating faults on a power distribution network having a plurality of breakers that can communicate with each other, comprising:
sensing, at a first breaker of the plurality of breakers, a fault on the power distribution network;
sending, by the first breaker, a first block to a second breaker and a second block to a third breaker of the plurality of breakers, each of the second breaker and the third breaker being coupled to one of two sides of the first breaker;
determining, by the first breaker, whether it received a first block from the second breaker and a second block from the third breaker; and
tripping, by the first breaker, based on a determination of whether the first block and the second block are received.

13. The method of claim 12, comprising sending, by the first breaker, based on the determination whether the first breaker received the first block from the second breaker, a transfer trip to the second breaker causing the second breaker to trip.

14. The method of claim 13, comprising identifying the fault as being located on a segment of the power distribution network based on information indicating that the first and second breakers have tripped.

15. The method of claim 13, wherein the second breaker and the third breaker each receive two blocks.

16. A power protection system, comprising:
a first source coupled to a first bus through a first source breaker;
a second source coupled to a second bus through a second source breaker;
a first set of loads coupled to the first bus;
a second set of loads coupled to the second bus; and
one or more generators coupled to a generator bus through a plurality of generator breakers such that each generator is coupled to the generator bus by a different generator breaker, the one or more generators being coupled to the first set of loads through respective ones of the plurality generator breakers, a first generator bus breaker and a first bus load breaker and being coupled to the second set of loads through the respective ones of the plurality generator breakers, a second generator bus breaker and a second bus load breaker; and
wherein the first bus load breaker and the second bus load breaker are configured to communicate using one or more of a health signal, a request to close signal, a request to open signal, a watchdog signal, or a breaker status signal.

17. The power protection system of claim 16, wherein the health signal and the request to close signal are used to effect a control scheme in which one of the one or more generators is selected as a preferred source for feeding the first set of loads or the second set of loads.

18. The power protection system of claim 16, wherein the health signal, the request to open signal, and the request to close signal are used to effect a control scheme to recover from a loss of either the first source or the second source.

19. The power protection system of claim 16, wherein the health signal, the request to open signal, and the request to close signal are used to effect a control scheme to recover from a loss of the first source and the second source.

20. The power protection system of claim 16, wherein the health signal and the request to open signal are used to effect a control scheme in which either the first source or the second source is used to supply the first set of loads and the second set of loads.
